(19) United States
(12) Patent Application Publication
(10) Pub. No.: US 2007/0118650 A1
(43) Pub. Date: May 24, 2007

(54) Data input/output system, data input/output server, and data input/output method

(75) Inventor: Yoshinori Sugahara, Kyoto-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/598,996

(22) Filed: Nov. 14, 2006

(30) Foreign Application Priority Data
Nov. 21, 2005 (JP) 2005-335874

(51) Int. Cl. G06F 15/173

(52) U.S. Cl. 709/225

(57) ABSTRACT

The present invention provides a data input/output system, a data input/output server, and a data input/output method in which it is possible to implement unitary security management in a simple manner by changing the input and output control of data based on the security standards provided for each function. In the data input/output system, the server has a data control section for controlling a data storage section, a device control section having an output device control section for outputting data to an output device and an input device control section for converting input data, and a function control section for executing a plurality of functions by controlling the data control section, the device control section, and a security management section for managing the security based on the security standards provided for each function executed by the function control section.

This application is based on Japanese Patent Application No. 2005-335874 filed on Nov. 21, 2005, in Japanese Patent Office, the entire content of which is hereby incorporated by reference

### TECHNICAL FIELD OF THE INVENTION

The present invention relates to data input and output systems, data input and output servers, and data input and output methods.

### BACKGROUND OF THE INVENTION

In recent years, because of the widespread use of computers, progress is being made in converting all kinds of documents into their electronic forms. Document preparation software such as word processors, etc., are used and files are prepared electronically and stored in a hard disk. In a corporate environment, servers are mutually connected by a network and very often large volumes of document files are shared among a plurality of users.

In general, a multi function terminal (Multi Function Peripheral, hereinafter abbreviated as MFP) has an input section such as a scanner or a fax etc., and an output section such as a printer etc., and has the function of carrying out data processing on input data such as texts or images and then printing them out. In recent years, developments have been made by which data sharing system functions are realized in MFPs so that several MFPs can be connected to each other via a network, and the text or image files that have been stored in the large capacity storage devices such as hard disks of the servers that operate in cooperation with MFPs are shared among a plurality of users.

In this manner, in an MFP having data sharing system functions, since a plurality of users access the information stored in the MFP, products are being supplied that provide the user registration and authentication functions in the MFP, so that the equipment cannot be used if the user is not authenticated. In addition, a method of ensuring security has been proposed (see, for example, Japanese Unexamined Patent Application Open to Public Inspection No. 2001-358891) by outputting image data after judging whether it is permissible or not to output the image data to that department with management information for each department being held by the MFP.

Furthermore, even a method has been proposed (see, for example, Japanese Unexamined Patent Application Open to Public Inspection No. 2003-337682) of providing security levels for each data, and to carry out output restrictions such as whether or not data can be printed out when being output.

However, in the method disclosed in, for example, Japanese Unexamined Patent Application Open to Public Inspection No. 2001-358891, although security levels can be set for each department, a method of setting detailed security levels depending on the function of the MFP or the personal information of the user has not been proposed. Even if it is set, it is necessary to modify the processing programs of the MFP, and there was the problem that this took considerable time and effort.

Further, in the method disclosed in Japanese Unexamined Patent Application Open to Public Inspection 2003-337682, it is necessary to set the security level for each data at the time of inputting the data, and there was the problem that this subjected the user to considerable effort.

### SUMMARY

The present invention was made in view of the above problems, and a purpose of the present invention is to provide a data input/output system, a data input/output server, and a data input/output method by which it is possible to carry out unitary security management in a simple manner by deciding (changing) the input/output control of data based on the security standards set for each function. In view of forgoing, one embodiment according to one aspect of the present invention is a data input/output system, comprising:

an input device connected to a network;

an output device connected to the network;

a server connected to the network; the server including:

a data storage section for storing data;

a data control section for controlling the data storage section;

a device control section; the device control section having:

an output device control section for converting data and outputting the converted data to the output device; and

an input device control section for converting data input by the input device,

a function control section for controlling the data control section and the device control section to execute a plurality of functions;

a security information storage section for storing security standards which are set for each function to be executed by the function control section ; and

a security management section for managing security based on the security standards,

wherein, the security management section conducts a judgment based on the security standards, and the function control section decides a content of the control based on a result of the judgment.

According to another aspect of the present invention, another embodiment is a data input/output server connected to a network, comprising:

a data storage section for storing data;

a data control section for controlling the data storage section;

a device control section; the device control section including:

an output device control section for converting data and outputting the converted data to the output device; and

an input device control section for converting data input by the input device,

a function control section for controlling the data control section and the device control section to execute a plurality of functions;

a security information storage section for storing security standards which are set for each function to be executed by the function control section ; and

a security management section for managing security based on the security standards,

wherein, the security management section conducts a judgment based on the security standards, and the function control section decides a content of the control based on a result of the judgment.

According to another aspect of the present invention, another embodiment is a data input/output method for controlling data stored in a server and an output device connected to the server, the method comprising the steps of:

receiving specifying information related to specifying the data stored in the server and the output device for outputting the data;

judging about the control of the data and a function of the output device based on the received specifying information and a security standard stored in the server; and

controlling the data and the function of the output device based on the judgment.

### BRIEF DESCRIPTION OF THE DRAWINGS

FIG. 1 is a block diagram showing an example of the overall configuration of an input/output system 100 according to a preferred embodiment of the present invention.

FIG. 2 is a block diagram showing an example of the internal configuration of a server 1 according to a preferred embodiment of the present invention.

FIG. 3 is an explanatory diagram for explaining the directory structure of the data stored in a data storage section 15 according to the present preferred embodiment.

FIG. 4 is a flowchart explaining the procedure for selecting and executing the functions of the input/output system 100 after the user logs in the input/output system 100 in a preferred embodiment of the present invention.

FIG. 5 is a flowchart explaining the procedure executed by the security counter measures conditions judgment routine when the user selects the application function 2 in a preferred embodiment of the present invention.

FIG. 6 is a flowchart explaining the procedure executed by the security counter measures conditions judgment routine when the user selects the application function 3 in a preferred embodiment of the present invention.

FIG. 7 is a flowchart explaining the procedure of changing the security standards in a preferred embodiment of the present invention.

FIG. 8 is a flowchart explaining the procedure of automatic selection of similar functions in a preferred embodiment of the present invention.

### DETAILED DESCRIPTION OF THE PREFERRED EMBODIMENT

A preferred embodiment of the present invention is explained in the following referring to the drawings. While the preferred embodiments of the present invention have been described using specific terms, such description is for illustrative purpose only, and it is to be understood that changes and variations may be made without departing from the spirit or scope of the appended claims.

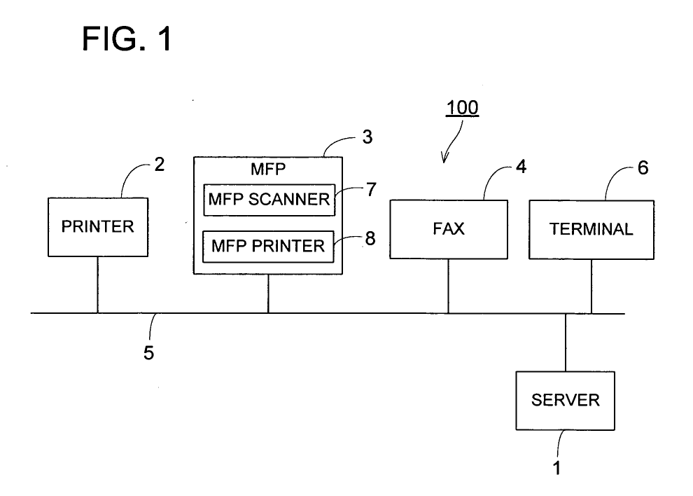

Firstly, the first preferred embodiment of the present invention is explained referring to FIG. 1.

FIG. 1 is a block diagram showing an example of the overall configuration of an input/output system 100 according to a preferred embodiment of the present invention.

The terminal 6 is, for example, a personal computer configured to have a keyboard, mouse, and display, not shown in the figure, and the data of text documents, images, speech, etc., is prepared in the terminal 6. The data prepared in the terminal 6 is transmitted to the server 1 via a network 5 configured using a rooter or a hub, not shown in the figure, by a communication section, not shown in the figure, that carries out communication, for example, via Ethernet (registered trademark) or telephone lines of the terminal 6. Further, the network 5 can be a LAN (Local Area Network) or can be the Internet.

The server 1 stores the data input from the terminal 6 or the MFP scanner 7, etc., and has the function of outputting the data after converting it into output data with a prescribed format. More detailed explanations of the server will be given later.

The printer 2 is, for example, a Laser Beam Printer (LBP) or an ink jet printer, etc.

The MFP 3 is a Multi Function Peripheral (MFP), and is provided with an MFP scanner 7 that inputs text documents or images, and an MFP Printer 8 that prints out text documents or images.

The Printer 2 and the MFP Printer 8 receive by a communication section, not shown in the figure, the data transmitted from the server 1 via the network 5, and prints out text documents or images. Further, the data of text documents or images scanned by the MFP scanner 7 can be transmitted to the server 1 via the network 5 and can be stored.

The FAX 4 is a facsimile unit that receives by a communication section, not shown in the figure, the data transmitted from the server 1 via the network 5, and transmits to an external device the modulated data via telephone lines, not shown in the figure. Also, it has the function of receiving text document and image data and printing it out.

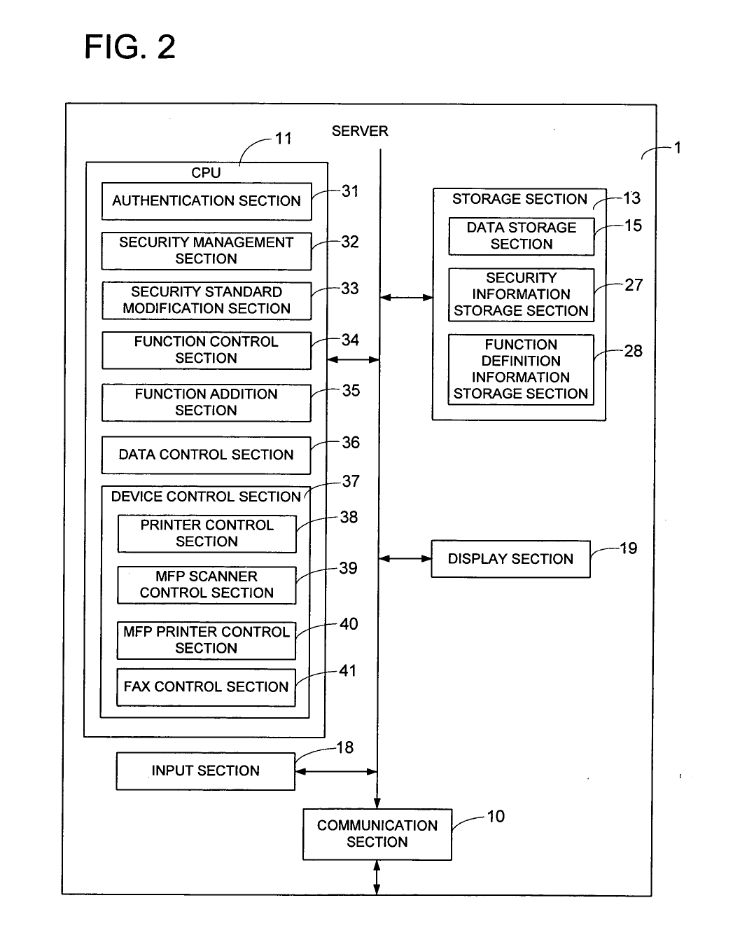

FIG. 2 is a block diagram showing an example of the internal configuration of a server 1 according to a preferred embodiment of the present invention.

The server 1 is, for example, a data server configured to have an input section 18 such as a keyboard, mouse, not shown in the figure, and a display section such as a display device, and is provided with a communication section 10 that carries out communication through Ethernet (registered trademark), etc., a CPU 11 that controls the entire server 1, and a storage section 13 that is configured to have a RAM, a ROM, and an HDD (Hard Disk Drive), etc., not shown in the figure. The storage section 13 stores, for example, the OS (Operating System), a program for recording the data for the printer, application programs, printer driver, etc., and the CPU 11 executes all these programs.

The authentication section 31 of the CPU 11 is the authentication section of the present preferred embodiment, and carries out authentication by comparing the personal information (for example, the user ID and password) input by the user from the terminal or the input section 18 with the personal information registered in the data storage section 15.

The function control section 34 is the function control section of the present invention, and executes the function defined by the function definition information stored in the function definition information storage section 28 by controlling the data control section 36 and the device control section 37. The data control section 36 has the function of controlling the input and output of data stored in the data storage section 15, and carries out storage and read out of data such as text document or image data in prescribed directories.

The function addition section 35 is the function addition section of the present invention, and has the function of adding function definitions to the function definition information storage section 28.

The device control section 37 is the device control section of the present invention. The device control section 37 is provided with a printer control section 38, an MFP scanner control section 39, an MFP printer control section 40, and a FAX control section 41.

The printer control section 38, the MFP printer control section 40, and the FAX control section 41 are the output device control sections of the present invention, and respectively control the printer 2, the MFP printer 8, and the FAX 4, and have the function of converting the obtained data into the prescribed format.

The MFP scanner control section 39 is the input device control section of the present invention, and has the function of scanning images or text documents by controlling the MFP scanner 7 and converting the obtained data into the prescribed format.

The security management section 32 is the security management section of the present invention, and judges, based on the security standards stored in the security information storage section 27, judges the conditions of the security countermeasures executed for each function. As is explained in detail later, the function control section 34 decides (changes) the details of the control based on the result of judgment by the security management section 32.

The security standard changing section 33 is the security standard changing section of the present invention.

The security standard changing section 33 reflects in the security standards the changes input, for example, from the terminal 6, by a user having the rights to change the security standards, and stores the changes in the security information storage section 27. Detailed explanation will be given later about changing the security standards.

Next, an example of the data stored in the data storage section 15 is described below.

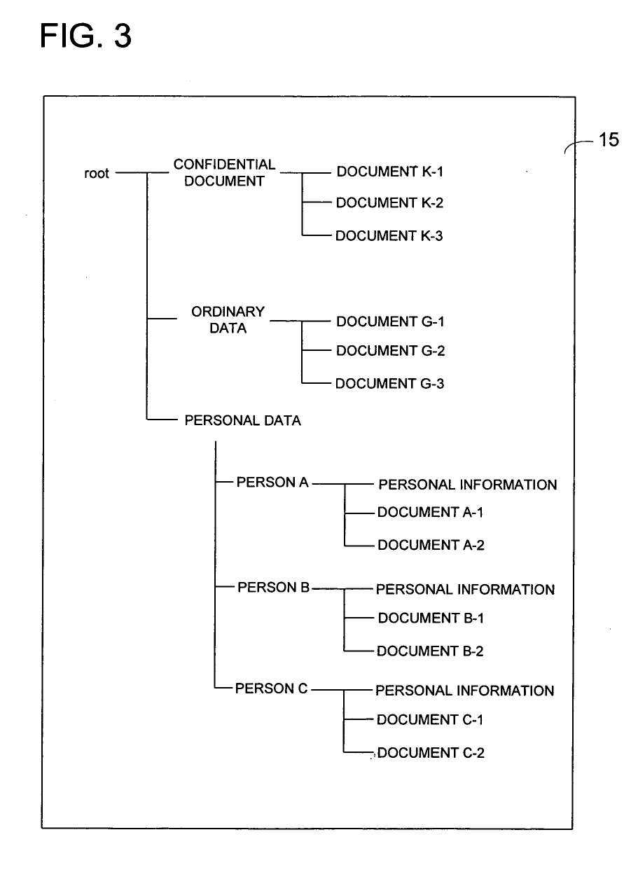

FIG. 3 is an explanatory diagram for explaining the directory structure of the data stored in the data storage section 15 according to the present preferred embodiment.

As shown in FIG. 3, confidential documents, ordinary data, and personal data are present in the root directory of the data storage section 15, and the data are classified and stored according to the level of confidentiality of the respective data. In the levels below the personal data, directories are provided for each individual such as, for example, Person A, Person B, and Person C, in which are stored the personal information and the documents for that person. The personal information includes, for example, the user ID, password, name, affiliated department, position, etc.

In the present preferred embodiment, personal information such as that shown in the example in Table 1 is stored.

TABLE 1

| | Person A | Person B | Person C |
|---|---|---|---|
| Position | Department | Section Manager | Ordinary |
| | Manager | | Employee |
| Name | Noboru Asama | Isogashi | Tarou Nippon |
| | | Bonkure | |
| User ID | asama | bonkure | nippon |
| Password | noboru | isogashi | tarou |

The entries Person A, Person B, and Person C in the first line of Table 1 are the names of the directories for each person, and the position, name, user ID, and password are stored in the respective directories. For example, in the directory of Person A, the personal information is stored in which the position is ‘Department Manager’, the name is ‘Noboru Asama’, the user ID is ‘asama’, and the password is ‘noboru’.

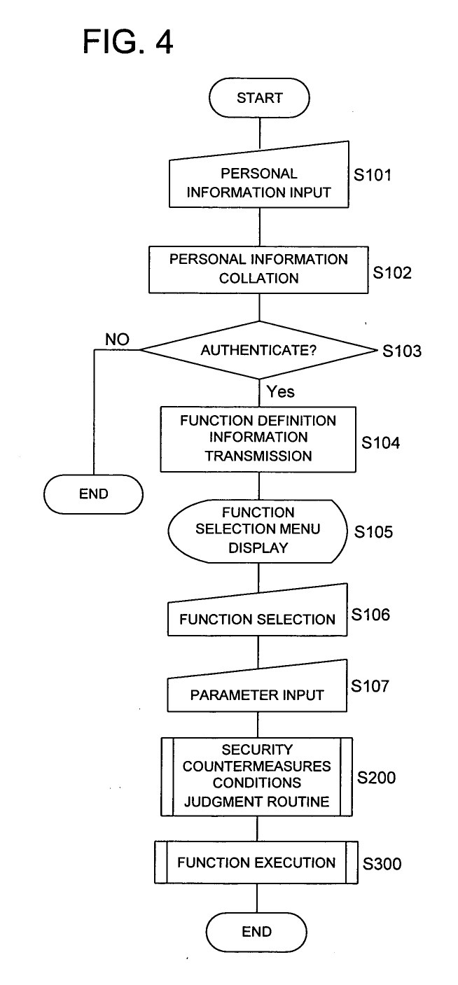

Next, the flow of data processing in the present preferred embodiment is described below using FIGS. 4 to 6.

FIG. 4 is a flowchart explaining the procedure for selecting and executing the functions of the input/output system 100 after the user has logged in the input/output system 100 in the present preferred embodiment of the present invention.

S101: This is the step in which the user inputs the personal information.

The user operates the terminal 6 and inputs the personal information (for example, user ID and password) (Step S101). The personal information input by the user is transmitted to the server 1 via the network 5. Further, although, to make it easy to understand, the following explanations are given assuming, for example, that the user has carried out the input operations in the terminal 6, it goes without saying that it is not necessary to restrict to this.

S102: This is the step in which the personal information input by the user is checked to see whether or not it matches with the personal information stored in the data storage section 15.

The authentication section 31 verifies whether the personal information received by the communication section 10 and transmitted from the terminal 6 matches with the personal information stored in the data storage section 15 (Step S102).

S103: This is the step of obtaining the result of the check in Step S102 and judging whether or not to authenticate.

When the personal information input by the user does not match with the personal information stored in the data storage section 15 (No in Step S103), the denial of authentication is posted to the terminal 6, and the operation is ended.

When the personal information input by the user matches with the personal information stored in the data storage section 15 (Yes in Step S103), the personal information is stored in the storage section 13, and the operation moves on to Step S104.

S104: This is the step in which the function definition information is transmitted to the terminal 6.

The function control section 34 transmits to the terminal 6 the function definition information stored in the function definition information storage section 28 from the communication section 10 via the network 5 (Step S104). The function definition information is described using Table 2. Table 2 is a table for explaining an example of the function definition information in the present preferred embodiment.

TABLE 2

| | Application | | | Application |
|---|---|---|---|---|
| | function 1 | Application | Application | function 4 |
| | Document | function 2 | function 3 | Document |
| | copying | Data input | Data output | copying |
| Details of | The data read | The data | The specified | The data |
| function | in from the | input from | data is | input from |
| | MFP scanner | the specified | output to the | the specified |
| | is output to | device is | specified | device is |
| | the MFP | stored in the | device. | output to the |
| | printer. | specified | | specified |
| | | directory. | | device. |
| Input | None | Input device | Data path | Input device |
| parameter | | | | |
| 1 | | | | |
| Input | None | Directory of | Output device | Output |
| parameter | | the data | | device |
| 2 | | storage | | |
| | | section | | |

The first line in this table is the function number assigned sequentially for each function such as Application Function 1, Application Function 2, Application Function 3, and Application Function 4. The second line in this table gives the name of the function to be executed, such as Document copying, Data input, and Data output. The third line gives the description of the function, the fourth line gives the input parameter 1, and the fifth line gives the input parameter 2. The input parameter 1 and the input parameter 2 are the parameters to be specified later in Step S107. The details of the function and the input parameter are described below for each function.

The detailed function of the application function 1 is “The data read in from the MFP scanner 7 is output to the MFP printer 8”, and this is a function used at the time of copying a document. Since the input device and the output device have been set beforehand as the MFP scanner and the MFP printer, respectively, the input parameter 1 and input parameter 2 to be input by the user are “None”.

The detailed function of the application function 2 is “The data input from the specified device is stored in the specified directory”, and this is a function used at the time of storing a document in the server. It is necessary to specify the input device as the input parameter 1 and the directory in the data storage section 15 as the input parameter 2. For example, the user specifies, by operating the terminal 6, the MFP scanner 7 as the input device and the directory of the confidential document in the storage section 15 as the directory in which to store the data read in from the MFP scanner 7.

The detailed function of the application function 3 is “The specified data is output to the specified device”, and this is a function used, for example, at the time of printing out the document stored in the server 1 in the printer 2. It is necessary to specify the data path as the input parameter 1 and the output device as the input parameter 2. For example, the user specifies, by operating the terminal 6, the document B-2 of the person B in the personal data directory in the data storage section 15 as the data path. In addition, the user specifies the printer 2 as the output device.

The detailed function of the application function 4 is “The data input from the specified device is output to the specified device”, and this is a function used, for example, at the time of outputting to the FAX 4 the data read in from the MFP scanner 7. It is necessary to specify the input device in the input parameter 1 and the output device in the input parameter 2. For example, the user specifies, by operating the terminal 6, the MFP scanner 7 as the input device and the FAX 4 as the output device.

S105: This is the step of displaying the function selection menu.

The terminal 6, based on the received function definition information, displays the function selection menu in the display not shown in the figure (Step S105). For example, in the example of Table 1, the application functions 1 to 4 are displayed.

S106: This is the step in which the user selects the function.

The user operates the terminal 6 and selects the function (Step S106). The terminal 6 transmits the information of the selected function to the server 1.

S107: This is the step in which the user inputs the parameters.

The user operates the terminal 6 and inputs the necessary parameters (Step S107). As has been described above, for example, in the case of the application function 2, the user operates the terminal 6 and specifies the MFP scanner 7 as the input device, and specifies the directory of the confidential document as the directory in the data storage section 15. For example, in the case of the application function 1, the operation proceeds automatically to the next step because it is not necessary to input any parameters.

The terminal 6 transmits the parameters that have been input to the server 1.

S200: This is the step in which the server judges the conditions for security countermeasures.

The security management section 32 that has received from the terminal 6 the information of the function selected by the user and parameters, when necessary, executes the security countermeasures conditions judgment routine based on the security standards (Step S200).

The security standards are explained below referring to Table 3.

TABLE 3

| | | Application | Application | | Application |
|---|---|---|---|---|---|
| | | function 1 | function 2 | Application function 3 | function 4 |
| | | Document | Data | Data | Document |
| | | copying | input | output | copying |
| Input | MFP | No security | No security | Not used | No security |
| device | Scanner | counter- | counter- | | counter- |
| control | | measures are | measures are | | measures are |
| | | taken | taken | | taken |
| Output | Printer | Not used | Not used | The data to which the | No security |
| device | | | | information of conditional | counter- |
| control | | | | output permission has been | measures are |
| | | | | assigned is output after adding | taken |
| | | | | to it the personal information | |
| | | | | of the user as a tint block | |
| | MFP | No security | Not used | The data to which the | No security |
| | Printer | counter- | | information of conditional | counter- |
| | | measures are | | output permission has been | measures are |
| | | taken | | assigned is output after adding | taken |
| | | | | to it the personal information | |
| | | | | of the user as a tint block | |
| | FAX | Not used | Not used | Outputting the data to which | Data output |
| | | | | the information of conditional | is prohibited |
| | | | | output permission has been | |
| | | | | assigned is prohibited | |
| Data | Confidential | Not used | Data storage is | Data output is prohibited when the | Not used |
| control | document | | prohibited if the | user is not of a managerial rank. | |
| | | | user is of a rank | In the case of users of a | |
| | | | lower than of | managerial rank, the information of | |
| | | | equal to | conditional output permission is | |
| | | | department | added to the data. | |
| | | | manager | | |
| | Ordinary | Not used | No security | No security countermeasures are | Not used |
| | data | | counter-measures | taken | |
| | | | are taken | | |
| | Personal | Not used | Data storage is | Data output is prohibited if the | Not used |
| | data | | prohibited if the | personal information of the user | |
| | | | personal | does not match with the personal | |
| | | | information of | information recorded in the data | |
| | | | the user does not | | |
| | | | match with the | | |
| | | | personal | | |
| | | | information | | |
| | | | recorded in the | | |
| | | | data | | |

The security standards in the present preferred embodiment are described below referring to Table 3. Table 3 is a table of the security standards set for each function in the present preferred embodiment.

To begin with, the security standards of the application function 1 given in Table 3 is explained below.

The input device control is the security standard related to the control of the input device. In the input/output system 100 of the present preferred embodiment, the input device is only the MFP scanner 7, and the security standard related to the MFP scanner has been shown as “No security countermeasures are taken”.

The output device control is the security standard related to the control of the output device. In the input/output system 100 of the present preferred embodiment, the output device used in the application function 1 is only the MFP printer 8, and the printer 2 and the FAX 4 are not used. Although the security standards have been shown for the different devices in Table 3, the security standard related to the MFP printer 8 used in the application function 1 has been shown as “No security countermeasures are taken”.

The row of data control shows the security standards related to the input and output control of the data stored in the data storage section 15. In the input/output system 100 of the present preferred embodiment, data is handled after classifying into confidential data, ordinary data, and personal data. Although the security standards related to the different data classes have been shown in Table 3, since no data input and output is made with respect to the data storage section 15 in the case of the application function 1, all entries have been shown as “Not used”.

In the case of the application function 1, since the security countermeasure has been entered as “No security countermeasures are taken” in the above manner, the security countermeasures conditions judgment routine does nothing and the operation proceeds to the next Step S300.

On the other hand, the application function 4 is the function of document copying in which the data input from the specified device is output to the specified device, and basically the security standards are also the same. However, in the present preferred embodiment, output to the FAX 4, which is likely to output data to an outside destination, has been prohibited.

Because of this, the security standard for the FAX 4 has been entered as “Data output is prohibited” in the case of application function 4 of Table 3. When the user specifies output to the FAX 4, the security management section 32 judges that the data output is to be prohibited as per the security standards.

The security standards conditions judgment routine executed in the cases of the application function 2 and the application function 3 will be described in detail later.

S300: This is the step of executing the function specified by the user.

The function control section 34 executes the function based on the result of judgment of the security countermeasures conditions of Step S200 (Step S300).

For example, even when the user has selected. the application function 2 of data input, if the result of judgment in Step S200 is “data storage prohibited”, the function control section 34 does not instruct the data control section 36 to store in the data storage section 15 the data specified by the user to the data control section 36, but posts the result of judgment to the terminal 6 and ends the processing.

Further, for example, in the case of the application function 3 of data output, if the result of judgment in Step S200 is “conditional data output permission”, the security management section 32 assigns the information of conditional data output permission to the data read out by the function control section 34 by issuing an instruction to the data control section 35. The function control section 34, in the case of data to which has been assigned the information of conditional data output permission, outputs the data along with the personal information of the user to, for example, the printer control section 38 of the device control section 37, and instructs the printer control section 38 to output the data after synthesizing the personal information of the user as the tint block with the data.

Further, if the result of judgment is “No security countermeasures are taken”, the function control section 34 does not carry out any particular security countermeasure related operations, but executes the functions defined in the function definition information.

In the manner described above, the function control section 34 is deciding (changing) the control of the data control section 36 and the device control section 37 based on the result of the security countermeasures conditions judgment routine.

Next, the security standards conditions judgment routine executed in the case of the application function 2 is described below.

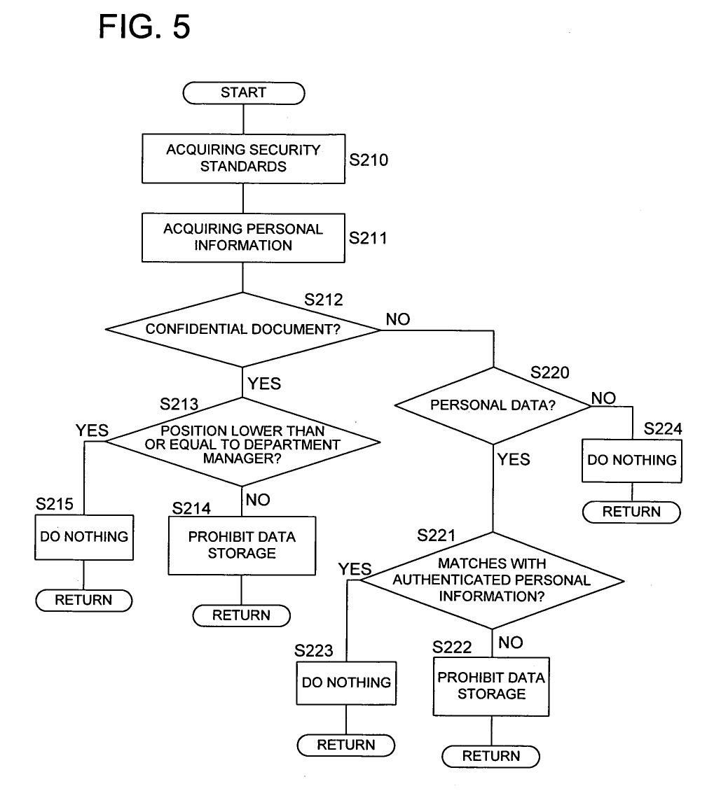

FIG. 5 is a flowchart explaining the procedure executed by the security countermeasures conditions judgment routine when the user selects the application function 2 in a preferred embodiment of the present invention.

S210: This is the step of acquiring the security standards.

The security management section 32 acquires the security standards for the application function 2 selected by the user from the security standards stored in the security information storage section 27 (Step S210).

The security standards for the application function 2 given in Table 3 are explained below.

Similar to the application function 1, the security standard related to the MFP scanner 7 which is the input device has been shown as “No security countermeasures are taken”.

No output device is used because the application function 2 is that of data input.

Data control is the security standard related to the input and output control of data stored in the data storage section 15. In the following steps, the security standards in Table 3 related to confidential documents, ordinary data, and personal data are explained.

S211: This is the step of acquiring the personal information.

The security management section 32 acquires the personal information of the user stored in the directory of the personal data in the data storage section 15 (Step S211).

The user inputs the personal information (for example, user ID and password) by operating the terminal 6. The personal information input by the user is transmitted to the server via the network 5. Further, although, to make it easy to understand, the following explanations are given assuming, for example, that the user has carried out the input operations in the terminal 6, it goes without saying that it is not necessary to restrict to this.

S212: This is the step of judging whether the directory of the data storage section 15 input by the user in the input parameter 2 is a confidential document or not. The security standard for the application function 2 is given in Table 3 as “Data storage is prohibited if the-user is of a rank lower than or equal to department manager”, and a judgment is made as to whether or not the data is a confidential document.

The security management section 32 judges whether or not the input parameter 2 transmitted from the terminal 6 and received by the communication section 10 is the directory of a confidential document in the data storage section 15 (Step S212).

S220: The security management section 32, if the result of judgment in Step S212 is that the directory is not that of a confidential document (No in Step S212), judges whether or not that directory is a directory of personal data (Step S220).

Similar to the security standard of the application function 2 given in Table 3, since the security countermeasures are different for personal data from that for ordinary data, a judgment is made in this step as to whether or not the data is a directory of personal data. The security management section 32 judges whether or not the input parameter 2 transmitted from the terminal 6 and received by the communication section 10 is the directory of a personal data in the data storage section 15.

S224: The security management section 32 returns to the original route without carrying out any security countermeasures if the result of judgment in Step S212 indicates that the data is not a directory of personal data (No in Step S220) (Step S224).

If the data is not a directory of personal data, that is, if it is an ordinary data, since the security standard given in Table 3 is “No security countermeasures are taken”, no security countermeasures are taken and the operation returns to the original routine.

S221: The security management section 32, if the result of judgment in Step S220 indicates that the data is a directory of the personal data (Yes in Step S220), carries out a judgment as to whether the personal information transmitted from an authenticated terminal 6 matches with the personal information stored in the directory of the data storage section 15 specified in the input parameter 2 (Step S221).

S222: The security management section 32 prohibits storage of data, if the result of judgment in Step S221 indicates that there is no match of the personal information (No in Step S221) (Step S222).

The Step S222 is the case of personal data, and the security management section 32 prohibits the storage of that data according to the security standard of “Data storage is prohibited if the personal information of the user does not match with the personal information recorded in the data” given in Table 3, and returns to the original routine.

S223: The security management section 32, if the result of judgment in Step S221 indicates that there is a match of personal information (Yes in Step S221), returns to the original routine without taking any security countermeasures (Step S223).

S213: The security management section 32, if the result of judgment in Step S212 indicates that it is the case of a confidential document (Yes in Step S212), refers to the personal information of the user, and checks whether or not the rank of the user is lower than or equal to a department manager (Step S213).

S214: If the result of judgment made by the security management section 32 in Step S213 is that it is a case of a user with a rank lower than or equal to a department manager (Yes in Step S213), the security management section 32 prohibits the storage of that data according to the security standard “Data storage is prohibited if the user is of a rank lower than or equal to department manager” given in Table 3, and returns to the original routine (Step S214).

S215: The security management section 32, if the result of judgment in Step S213 indicates that the rank of the user is not lower than or equal to a department manager (No in Step S221), returns to the original routine without taking any security countermeasures. In such a case, for example, it is possible that the rank of the user is of a executive level and there is no problem in security even if that user accesses a confidential document (Step S215).

The explanation of the security countermeasures conditions judgment routine executed in the case of the application function 2 has been narrated above.

Next, the security standards conditions judgment routine executed in the case of the application function 3 is described below.

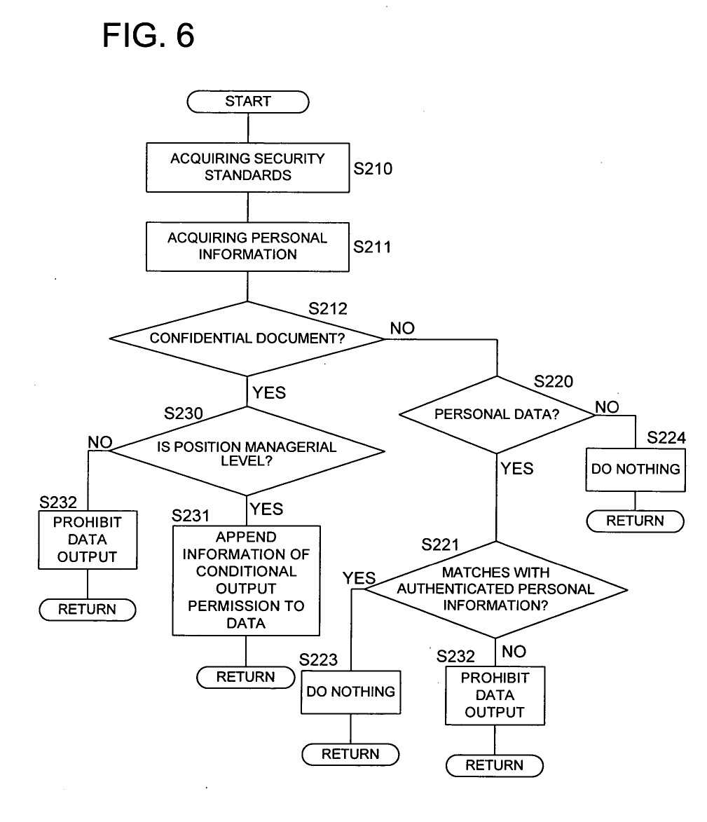

FIG. 6 is a flowchart explaining the procedure executed by the security counter measures conditions judgment routine when the user selects the application function 3 in the present preferred embodiment of the present invention. However, in the following, the same numbers are assigned to the steps having the same functions as in FIG. 5 and their explanations are omitted.

S210: This is the step of acquiring the security standards.

S211: This is the step of acquiring the personal information.

S212: This is the step of judging whether the directory of the data storage section 15 input by the user in the input parameter 2 is a confidential document or not.

The security management section 32 judges whether or not the input parameter 2 transmitted from the terminal 6 and received by the communication section 10 is the directory of a confidential document in the data storage section 15 (Step S212).

The security standard for the application function 3 is given in Table 3 as “Data output is prohibited when the user is not of a managerial rank. In the case of users of a managerial rank, the information of conditional output permission is added to the data”, and a judgment is made as to whether or not the data is a confidential document.

S220: The security management section 32, if the result of judgment in Step S212 is that the directory is not that of a confidential document (No in Step S212), judges whether or not that directory is a directory of personal data (Step S220).

Similar to the security standard of the application function 2 given in Table 3, since the security countermeasures are different for personal data from that for ordinary data, a judgment is made in this step as to whether or not the data is that of a directory of personal data.

The security management section 32 judges whether or not the input parameter 2 transmitted from the terminal 6 and received by the communication section 10 is the directory of a personal data in the data storage section 15.

S224: The security management section 32 returns to the original route without carrying out any security countermeasures if the result of judgment in Step S212 indicates that the data is not that of a directory of personal data (No in Step S212) (Step S224).

S221: The security management section 32, if the result of judgment in Step S212 indicates that the data is a confidential document (Yes in Step S212), carries out a judgment as to whether the personal information transmitted from an authenticated terminal 6 matches with the personal information stored in the directory of the data storage section 15 specified in the input parameter 2 (Step S221).

S233: The security management section 32 prohibits output of data, if the result of judgment in Step S221 indicates that there is no match of the personal information (No in Step S221) (Step S233).

The Step S222 is for the case of personal data, and the security management section 32 prohibits the output of that data according to the security standard of “Data output is prohibited if the personal information of the user does not match with the personal information recorded in the data” given in Table 3, and returns to the original routine.

S223: The security management section 32, if the result of judgment in Step S221 indicates that there is a match of personal information (Yes in Step S221), returns to the original routine without taking any security countermeasures (Step S223).

S230: The security management section 32, if the result of judgment in Step S212 indicates that it is the case of a confidential document (Yes in Step S212), refers to the personal information of the user, and checks whether or not the rank of the user is of a managerial level (Step S230).

S232: If the result of judgment made by the security management section 32 in Step S230 is that it is a case of a user with a rank other than a managerial level (No in Step S230), the security management section 32 prohibits the output of that data according to the security standard “Data output is prohibited when the user is not of a managerial rank. In the case of users of a managerial rank, the information of conditional output permission is added to the data” given in Table 3, and returns to the original routine (Step S232).

S231: If the result of judgment made by the security management section 32 in Step S230 is that it is a case of a user with a rank of a managerial level (Yes in Step S230), the security management section 32 attaches the information of conditional data output permission to the data, for example, in the header part of the data.

The explanation of the security countermeasures conditions judgment routine executed in the case of the application function 3 has been narrated above.

Thus, in the above, although explanations have been given of the security standards in the present preferred embodiment shown in Table 3, the preferred embodiment is not to be limited to this example, and it is possible to set in detail the security standards according to the workplace of the organization. For example, it is possible to realize easily that the user rank that unconditionally permits data output can be changed depending on the workplace, and changes can be done so that tint block of personal information is added to all the data outputs, by changing the security standards.

Next, the procedure for changing the security standards is explained below.

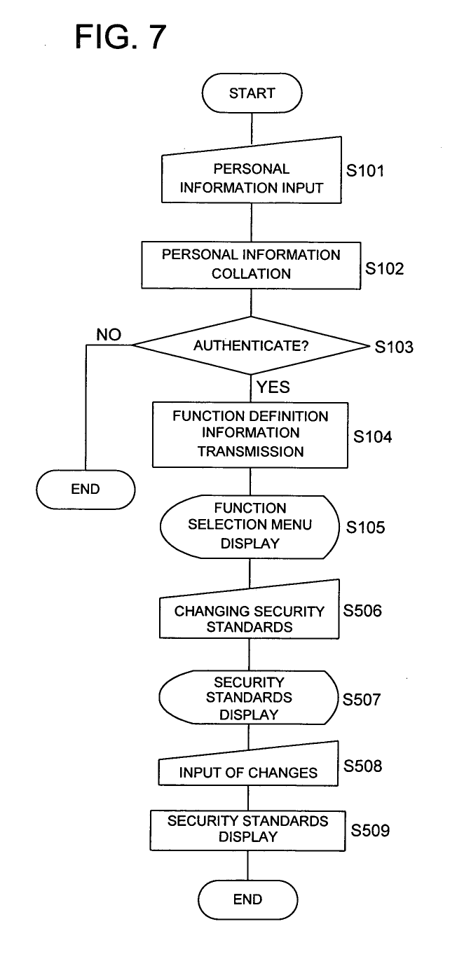

FIG. 7 is a flowchart explaining the procedure of changing the security standards in a preferred embodiment of the present invention. Since the steps S101 to S105 have the same functions as those described in FIG. 4, the same numbers have been assigned, and a part of the explanations is omitted.

S101: This is the step in which the user inputs the personal information.

S102: This is the step in which the personal information input by the user is checked to see whether or not it matches with the personal information stored in the data storage section 15.

S103: This is the step of obtaining the result of the check in Step S102 and judging whether or not to authenticate.

When the personal information input by the user does not match with the personal information stored in the data storage section 15 (No in Step S103), the denial of authentication is posted to the terminal 6, and the operation is ended.

When the personal information input by the user matches with the personal information stored in the data storage section 15 (Yes in Step S103), the personal information is stored in the storage section 13, and the operation moves on to Step S104.

S104: This is the step in which the function definition information is transmitted to the terminal 6.

When the user has the rights to change the security standards, the function control section 34 transmits the function definition information including the function of changing the security standards (Step S104).

S105: This is the step of displaying the function selection menu.

The function of changing the security standards is displayed in the function selection menu (Step S105).

S506: This is the step in which the user selects the function.

The user selects the function by operating the terminal 6. The terminal 6 transmits the information of the selected function to the server 1. Here, it is assumed that the function of changing the security standards has been selected (Step S506).

S507: This is the step of displaying the security standards.

The security standards received from the security standard modification section 33 are displayed in the display of the terminal 6 (Step S507).

S508: This is the step of inputting the changes in the security standards.

The user inputs the changes in the security standards from the terminal 6 (Step S508).

S509: This is the step of changing the security standard and storing in the security information storage section.

The security standard modification section 33 changes the security standards stored in the security information storage section 27, based on the information of changes in the security standards received from the terminal 6, and stores them in the security information storage section 27.

The procedure of changing the security standards is as above.

Next, in case of adding a function, the procedure of automatically selecting the security standards for the function to be added is explained below.

In the present preferred embodiment, an implementation example of adding the application function 5 to the four functions described in Table 2 is explained below.

Table 4 shows the function definition information including the application function 5.

TABLE 4

| | Application | Application | Application | | Application |
|---|---|---|---|---|---|
| | function 1 | function 2 | function 3 | Application function 4 | function 5 |
| | Document | Data | Data | Document | Document |
| | copying | input | output | copying | copying |
| Details of | The data read | The data input | The specified | The data input from | The data read in |
| function | in from the | from the | data is output | the specified device | from the MFP |
| | MFP scanner | specified | to the | is output to the | scanner is |
| | is output to | device is | specified | specified device | output to the |
| | the MFP | stored in the | device | | specified device |
| | printer | directory | | | |
| Parameter 1 | None | Input device | Data path | Input device | Output device |
| Parameter 2 | None | Directory of | Output device | Output device | None |
| | | the data | | | |
| | | storage | | | |
| | | section | | | |

The application function 5 is explained using Table 4. However, since the application functions 1 to application function 4 are the same as in Table 2, their explanation will be omitted. The function name of the application function 5 is document copying which is the same as that of application function 1 and application function 4. The detail of the function is “The data read in from the MFP scanner is output to the specified device”, the input parameter 1 is “Output device”, and the input parameter 2 is “None”.

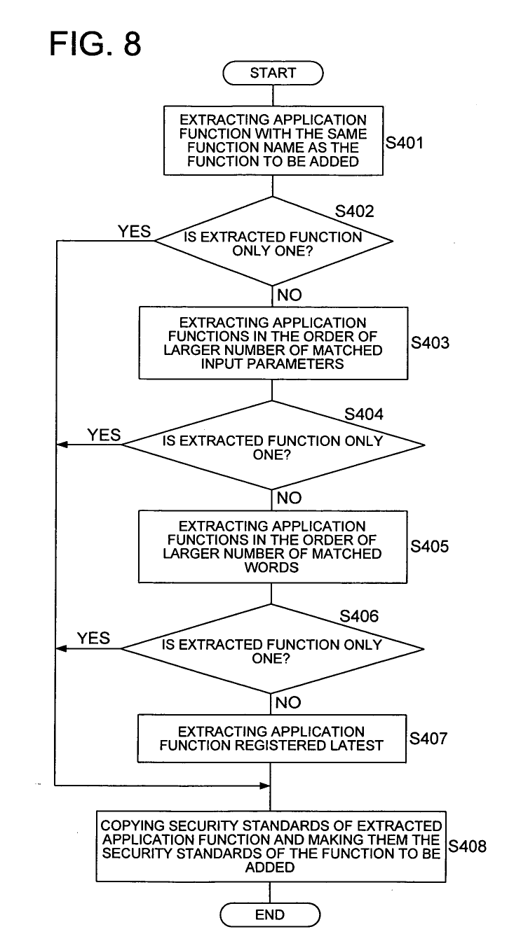

Next, the procedure of automatically selecting a function similar to the application function 5 to be added is explained below using FIG. 8.

FIG. 8 is a flowchart explaining the procedure of automatic selection of similar functions in a preferred embodiment of the present invention.

S401: Extract the application function having the same function name as the function name of the function to be added.

The function addition section 35 extracts from the function definition information the application function having the same function name as the function name of the function to be added (Step S401).

In the example of Table 4, the application functions having the same function name of “Document copying” as the application function 5 are the application function 1 and the application function 4 .

S402: This is the step of judging whether the extracted application function is only one or more (Step S402).

The function addition section 35 proceeds to Step S403 if the result of extraction in Step S402 indicates two or more application functions (No in Step S402).

The authentication section 22, when only one application function has been extracted (Yes in Step S402), proceeds to Step S408 because an application function has been selected. Further, since the function name of the application function to be added is selected from the function names that have been prepared earlier, always one function name will match.

S403: Application functions are extracted in the order of the larger number of matching input parameters (Step S403).

In the example of Table 4, the input parameter of the application function 5 is “Output device”, one input parameter of application function 4 matches with this application function. Since no parameter matches with the application function 1, the order of the larger number of matching input parameters is—application function 4, application function 1.

S404: This is the step of judging whether the number of extracted application functions is only one (Step S404).

The function addition section 35 proceeds to Step S405 if two or more application functions have been extracted as a result of extraction in Step S403 (No in Step 404).

The authentication section 22, when only one application function has been extracted (Yes in Step S404), proceeds to Step S408 because an application function has been selected. In the example of Table 4, the application function with the larger number of matching input parameters is application function 4 which is selected in this step.

S405: Extracts the application function in the order of larger number of matching words.

The application function is extracted in the order of larger number of matching words in the entered details of function (Step S405).

S406: This is the step of judging whether the number of extracted application functions is only one (Step S406).

The function addition section 35 proceeds to Step S407 if two or more application functions have been extracted as a result of extraction in Step S405 (No in Step S405).

The authentication section 22, when only one application function has been extracted (Yes in Step S406), proceeds to Step S408 because an application function has been selected.

S407: The application function that has been registered latest is extracted.

The application function that has been registered latest is extracted from among those extracted in Step S405.

Using the steps up to this point, one application function has been extracted that is closest to the application function to be added.

S408: The security standards of the extracted application function are copied and set as the security standards of the function being added (Step S408).

In the example of Table 4, the application function with the larger number of matching input parameters is application function 4, and the application function 4 has been extracted in Step S404. In Step S408, the function addition section 35 copies the security standards of the application function 4. and adds them as the security functions of the application function 5 which the additional function.

Table 5 is a table of security standards to which the security standards of the application function 5 have been added.

TABLE 5

| | | Application | Application | | Application | Application |
|---|---|---|---|---|---|---|
| | | function 1 | function 2 | Application function 3 | function 4 | function 5 |
| | | Document | Data | Data | Document | Document |
| | | copying | input | output | copying | copying |
| Input | MFP | No security | No security | Not used | No security | No security |
| device | Scanner | counter- | counter- | | counter- | counter- |
| control | | measures | measures | | measures are | measures are |
| | | are taken | are taken | | taken | taken |
| Output | Printer | Not used | Not used | *1 | No security | No security |
| device | | | | | counter- | counter- |
| control | | | | | measures are | measures are |
| | | | | | taken | taken |
| | MFP | No security | Not used | *1 | No security | No security |
| | Printer | counter- | | | counter- | counter- |
| | | measures | | | measures are | measures are |
| | | are taken | | | taken | taken |
| | FAX | Not used | Not used | Outputting the data to | Data output | Data output |
| | | | | which the information of | is prohibited | is prohibited |
| | | | | conditional output | | |
| | | | | permission has been | | |
| | | | | assigned is prohibited | | |

*1: The data to which the information of conditional output permission has been assigned is output after
adding to it the personal information of the user as a tint block

| | | | | | | |
|---|---|---|---|---|---|---|
| Data | Confidential | Not used | Data storage | Data output is | Not used | Not used |
| control | document | | is | prohibited when | | |
| | | | prohibited | the user is not | | |
| | | | if the user | of a managerial | | |
| | | | is of a rank | rank. | | |
| | | | lower than | In the case of | | |
| | | | of equal to | users of a | | |
| | | | department | managerial rank, | | |
| | | | manager | the information | | |
| | | | | of conditional | | |
| | | | | output permission | | |
| | | | | is added to the | | |
| | | | | data. | | |
| | Ordinary | Not used | No security | No security | Not used | Not used |
| | data | | counter- | countermeasures | | |
| | | | measures are | are taken | | |
| | | | taken | | | |
| | Personal | Not used | *1 | *2 | Not used | Not used |
| | data | | | | | |

*1: Data storage is prohibited if the personal information of the user does not
match with the personal information recorded in the data
*2: Data output is prohibited if the personal information of the user does not match
with the personal information recorded in the data

As is shown in Table 5, the security standards of the application function 4 have been copied and have become the security standards of the application function 5 which is the additional function.

In the above manner, according to the present preferred embodiment, it is possible to provide a data input/output system, a data input/output server, and a data input/output method in which it is possible to implement unitary security management in a simple manner using a security management section that can change the input and output control of data based on the security standards provided for each function.

What is claimed is:

1. A data input/output system, comprising:
an input device connected to a network;
an output device connected to the network;
a server connected to the network; the server including:
a data storage section for storing data;
a data control section for controlling the data storage section;
a device control section; the device control section having:
an output device control section for converting data and outputting the converted data to the output device; and
an input device control section for converting data input by the input device,
a function control section for controlling the data control section and the device control section to execute a plurality of functions;
a security information storage section for storing security standards which are set for each function to be executed by the function control section ; and
a security management section for managing security based on the security standards,
wherein, the security management section conducts a judgment based on the security standards, and the function control section decides a content of the control based on a result of the judgment.

2. The data input/output system of claim 1, comprising:
an authentication section for authenticating a user based on personal information of a user,
wherein the function control section decides the content of the control based on a result of a judgment conducted by the security management section based on the security standards and personal information of a user authenticated by the authentication section.

3. The data input/output system of claim 1, wherein the security standards include personal information of a user.

4. The data input/output system of claim 1, wherein the security standards include a limitation condition for deciding the control of the function control section according to degree of security of the data.

5. The data input/output system of claim 4, the limitation condition includes a condition regarding permission/prohibition of the input/output of the data from the input device, to the output device and to the data storage section and a condition regarding information added to the data.

6. The data input/output system of claim 4, comprising:
a security standard modification section for modifying the security standards,
wherein the security standard modification section modifies the security standards based on authority of the user authenticated by the authentication section.

7. The data input/output system of claim 6, comprising:
a function addition section for adding a function to the function control section,
wherein the security standard modification section copies the security standard of the function which is the most similar to a function added by the function addition section and set the copied security standard as a security standard for the function to be added.

8. The data input/output system of claim 7, wherein the data input/output system includes function definition information which defines each function of the function control section, and the function addition section selects the function definition information which is the most similar to the function to be added and set the selected function definition information as a function definition information of the function to be added.

9. The data input/output system of claim 8, wherein when the function addition section selects the function definition information which is the most similar to the function to be added, the function addition section selects the function definition information based on information of the input device and output device defined in the function definition information.

10. The data input/output system of claim 8, wherein when the function addition section selects the function definition information which is the most similar to the function to be added based on the function definition information, the function addition section select the function definition information based on a function description defined by the function definition information.

11. The data input/output system of claim 1, a content of the control which the function control section decides is one of the following steps of: prohibiting output of the data to the output device; prohibiting storage of the data in the data storage section, and outputting personal information of a user interpolated in the data as a tint block to the output device.

12. A data input/output server connected to a network, comprising:
a data storage section for storing data;
a data control section for controlling the data storage section;
a device control section; the device control section including:
an output device control section for converting data and outputting the converted data to the output device; and
an input device control section for converting data input by the input device,
a function control section for controlling the data control section and the device control section to execute a plurality of functions;
a security information storage section for storing security standards which are set for each function to be executed by the function control section ; and
a security management section for managing security based on the security standards,
wherein, the security management section conducts a judgment based on the security standards, and the function control section decides a content of the control based on a result of the judgment.

13. The data input/output server connected to a network of claim 12, comprising:
an authentication section for authenticating a user based on personal information of a user,
wherein the function control section decides the content of the control based on a result of a judgment conducted by the security management section based on the security standards and personal information of a user authenticated by the authentication section.

14. The data input/output server connected to a network of claim 12, wherein the security standards include personal information of a user.

15. The data input/output server connected to a network of claim 12, wherein the security standards include a limitation condition for deciding the control of the function control section according to degree of security of the data.

16. A data input/output method for controlling data stored in a server and an output device connected to the server, the method comprising the steps of:
receiving specifying information related to specifying the data stored in the server and the output device for outputting the data;
judging about the control of the data and a function of the output device based on the received specifying information and a security standard stored in the server; and
controlling the data and the function of the output device based on the judgment.

17. The data input/output method of claim 16 for controlling data stored in a server and an output device connected to the server, wherein when the server receives the specifying information from the input device, the server conducts user authentication and judges about the data and the control of the function of the output device based on the specifying information, the security standard and personal information of an authenticated user.

18. The data input/output method of claim 16 for controlling data stored in a server and an output device connected to the server, wherein the security standard includes personal information of a user.

19. The data input/output method of claim 16 for controlling data stored in a server and an output device connected to the server, wherein the security standard includes a limitation condition for deciding the control of the function control section according to degree of security of the data.
